(19) United States
(12) Patent Application Publication
(10) Pub. No.: US 2016/0219795 A1
(43) Pub. Date: Aug. 4, 2016

(54) EDIBLE PLANTS IN SOILLESS MEDIA

(71) Applicant: Elie H. Gendloff, Encinitas, CA (US)

(72) Inventor: Elie H. Gendloff, Encinitas, CA (US)

(21) Appl. No.: 15/005,379

(22) Filed: Jan. 25, 2016

Related U.S. Application Data
(60) Provisional application No. 62/110,635, filed on Feb. 2, 2015.
(60) Provisional application No. 62/220,742, filed on Sep. 18, 2015.

(51) Int. Cl. A01G 9/02; G06Q 90/00; B65D 85/52

(52) U.S. Cl. CPC A01G 9/021; B65D 85/52; G06Q 90/00

(57) ABSTRACT

Provided is an edible plant, alive and growing in a container comprising a porous, solid medium or a solid mixture of porous media, transported from its growing area to a food vendor. Also provided is a food vendor selling the above edible plant. Additionally provided is a method of providing an edible plant to a food vendor. Also, a rigid container suitable for plant growth is provided, further comprising a porous solid medium or a solid mixture of porous media inserted therein, wherein the medium is capable of supporting plant growth. Additionally provided is a cover fitting inside a top of a container for growing plants

### CROSS-REFERENCE TO RELATED APPLICATIONS

This application claims the benefit of U.S. Provisional Application No. 62/110,635, filed Feb. 2, 2015, and U.S. Provisional Application No. 62/220,742, filed Sep. 18, 2015, both incorporated by reference in their entirety.

### BACKGROUND OF THE INVENTION

(1) Field of the Invention

The present invention generally relates to food production, distribution and use. More specifically, the invention is directed to food plants growing in containers and their distribution to restaurants and markets.

(2) Description of the Related Art

When a plant food ingredient such as a fruit or vegetable is harvested, the harvested ingredient responds to the harvesting injury within minutes (Reilly et al., 2003, Plant Mol. Biol. 53:669-685), leading to significant changes to the composition of that ingredient within hours of harvest (King, G. A. and S. C. Morris, 1994, J. Amer. Soc. Hort Sci. 119: 270-275; Afoakwa et al., 2001, Food chemistry 75:85-91; Ryoichi Masuda, pp. 92-102 in Vegetable Soybean: Research Needs for Production and Quality Improvement, S. Shanumgasandaram, Ed. 1991, ISBN: 92-9058-047-X; Degl'Innocenti et al., 2005, J. Agric. Food Chem. 53:9980-9984). For example, differences in broccoli toughness (“breaking force”) can occur within six hours of harvest (Baclayon et al., 2007, J. Biol. Sci. 7:614-619). Additionally, activity of the enzyme phenylalanine ammonia lyase (PAL) can change significantly within twelve hours of harvest (Bhowmik and Matsu, 2005, Z. Naturfursch. 60c:128-132). This change in PAL activity can exacerbate toughness, since PAL catalyzes the committed step in phenylpropanoid metabolism, which leads to lignin biosynthesis. Lignin is an important structural component in plant cell walls. Many flavor components of fruits and vegetables are also made through the phenylpropanoid pathway, indicating that changes in PAL likely lead to changes in flavor. Indeed, measurable changes in sensory panel scores have been demonstrated in soybeans within 10 hours of harvest (Masuda, 1991).

The early compositional changes in harvested ingredients increase over time, in an irreversible process termed “senescence,” which eventually leads to cellular breakdown and death of the ingredient. For this reason, fresh ingredients are an essential component of nutritious, high quality food.

Even though food ingredients begin to deteriorate within hours of harvest, restaurants do not generally use food ingredients that have been harvested less than a day before utilization due to the logistical difficulty in obtaining fresher ingredients, and because the rapidity of the changes in food after harvest has not been generally appreciated. Even restaurants that have gardens on site generally harvest the ingredients at least several hours before the food is prepared.

There is therefore a need for the provision of food plants that can be sold to consumers, groceries and restaurants and can be utilized in the kitchen, or harvested at a dining table without subjecting the diner or chef to loose plant growing media such as soil that can contaminate the cooking surface or dining table. The present invention addresses that need.

### BRIEF SUMMARY OF THE INVENTION

The present invention is directed to the provision of food plants growing in a solid medium and a container such that the plant can easily be transported to a grocer, or restaurant. Thus, provided is an edible plant, alive and growing in a container comprising a porous, solid medium or a solid mixture of porous media, transported from its growing area to a food vendor.

Also provided is a food vendor selling the above edible plant.

The present invention is also directed to a method of providing an edible plant to a food vendor. The method comprises providing the above edible plant.

Additionally provided is a rigid container suitable for plant growth comprising a porous solid medium or a solid mixture of porous media inserted therein, wherein the medium is capable of supporting plant growth.

Further provided is a cover fitting inside a top of a container for growing plants. In these embodiments, the cover is comprised of a water repellent material and has a center hole through which a plant can grow.

### BRIEF DESCRIPTION OF THE DRAWING

FIG. 1 is an exploded perspective view, showing the container, a solid medium or a solid mixture of porous media, a seed that may be planted in the solid medium or media, and the cover with center hole and slit extending from center hole to covers edge.

### DETAILED DESCRIPTION OF THE INVENTION

As used herein, the singular forms “a”, “an” and “the” are intended to include the plural forms as well, unless the context clearly indicates otherwise. Additionally, the use of “or” is intended to include “and/or”, unless the context clearly indicates otherwise.

U.S. patent application Ser. No. 14/145,972 (published as US 2014/0279714), and U.S. patent application Ser. No. 14/205,862 (published as US 2014/0279715), both incorporated by reference, describe the provision and use of food plants that are still alive and growing in a container, where they can be utilized in the kitchen or at a dining table as live plants that can be harvested minutes before used in food preparation and eaten. Prior to the introduction of that concept, the closest comparable utilization of plants is the harvesting of hydroponic plants with some roots still attached that are kept wet until utilized. However, the hydroponic plants generally need to be refrigerated until used since they usually do not have all their roots and they are removed from their growing environment. By contrast, the edible plants described in the above patent application and herein are undisturbed from their growing conditions, and do not need refrigeration. They also provide an attractive display that can be placed on a dining table or a kitchen countertop or shelf for storage, unrefrigerated. Additionally, the plants of the present invention can be returned to their growing conditions (e.g., greenhouse) if not sold or if rejected by the buyer, where they will continue to grow. The present invention provides the container-growing plants described above, that are growing in a porous, solid medium or a solid mixture of porous media, so that the media will not fall out of the container and contaminate the cooking surface or dining table.

Thus, the present invention is directed to an edible plant, alive and growing in a container comprising a porous, solid medium or a solid mixture of porous media, where the plant and container is transported from its growing area to a food vendor.

The present invention is not narrowly limited to any particular food vendor, but it encompasses any type of food vendor known in the art, e.g., a restaurant, food distributor, grocery, food truck, roadside stand, farmers market, retail store, online, event, theme park, and/or fairgrounds stand.

The invention is also not narrowly limited to any particular solid medium or solid mixture of porous media. Non-limiting examples of solid media include a mineral wool, for example made of glass, ceramic or stone, e.g., stone wool fiber such as rock wool, or a plastic foam such as HORTICUBE®, ROOTCUBE® or WEDGE®. In some embodiments, the plant is growing in a solid mixture of porous medium. Such solid mixture can include any natural or artificial material that is not toxic to plants. Nonlimiting examples include soil, vermiculite, perlite, peat, sand, and clay. The porous mixture can be held together by any means known in the art, e.g., paper or plastic netting.

The container can be any container suitable for growing plants. In some embodiments, the container is constructed of rigid plastic. In other embodiments, the container is constructed of terracotta, glazed ceramic and/or wood. The container can also be any size or shape, e.g., round, square, etc. In some embodiments, the container is square at the top and is from 2 inches to 5 inches on a side. In particular embodiments, the container is rigid plastic, square along the top, and 2″ in diameter.

Being in a container, the edible plant can be displayed until eaten, or displayed while parts of it are eaten. For example, a Caprese salad can utilize a live basil plant, where the diner can pick leaves off of the plant to be mixed with mozzarella and tomato, providing a unique presentation. For such a presentation, the container may be placed into an outer decorative container, or the outer decorative container can be sold with the plant inside.

The edible plant here may be grown by the food vendor or by a separate entity from the food vendor.

The edible plant can be any known plant that is capable of growing in the container. Non-limiting examples include tomato, pepper, bean, green onion, chive, leek, pea, cauliflower, Brussels sprout, celery, horseradish, asparagus, kale, spinach, lettuce, arugula, sorrel, endive, cabbage, bok choy, mustard, Swiss chard, basil, rosemary, thyme, cilantro, bay, dill, fennel, marjoram, mint, oregano, parsley, sage, savory, tarragon, chervil, dill, spearmint, watercress, lemon balm, rosemary, thyme, an edible flower, alfalfa sprouts, bean sprouts, quinoa sprouts, chia sprouts, white mushroom, shiitake mushroom, cremini mushroom, oyster mushroom, portabella mushroom, or truffle.

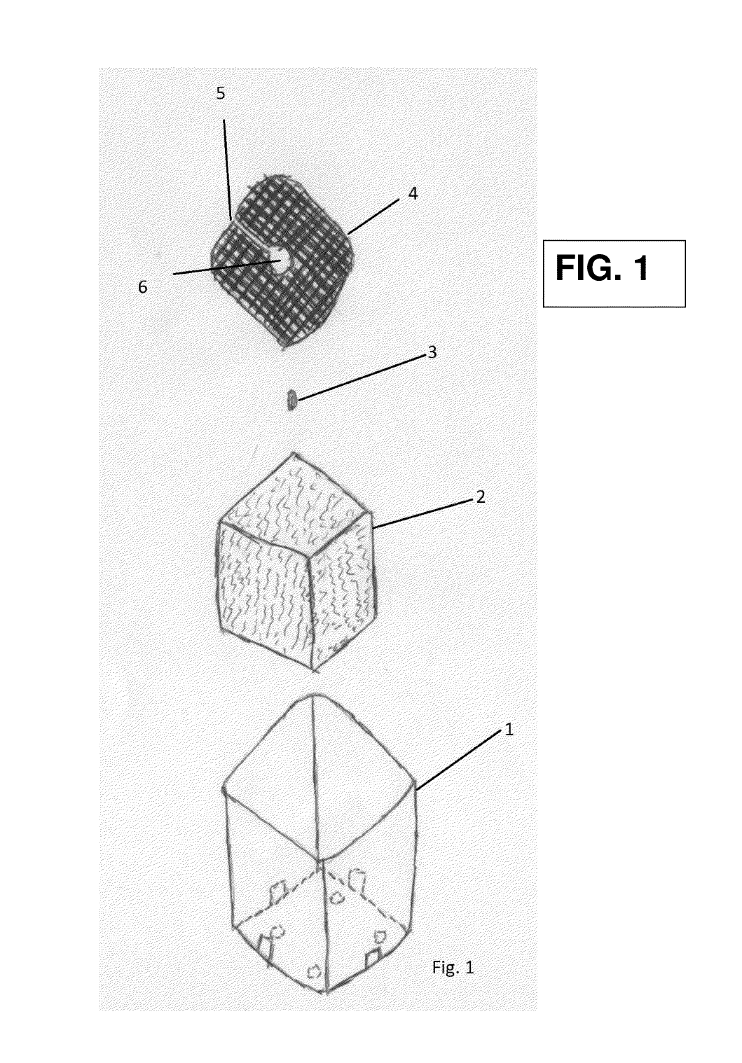

In some porous solid media, algae can grow on the surface, particularly if the media is exposed to sunlight. While not dangerous or toxic, the algae growth can be unsightly. Such algae growth can be reduced or prevented by placing a cover over the surface of the solid medium or solid mixture of porous media. The cover can be solid or porous, e.g., with holes to allow water or nutrient solution to pass through. In some embodiments, the cover is water repellent. The cover can be made of any suitable material, for example vinyl, tarpaulin, or acrylic fabric. In various embodiments, the cover has a hole, e.g., in the center, suitable to allow the plant to grow through. In some of those embodiments, the cover has a slit extending from the center hole to the covers edge, to allow easy addition or removal when the plant is growing in the container. The cover may be sized to cover the medium, or solid mixture of porous media. An example of such a cover is provided in FIG. 1 marked 4.

The edible plant-container-media compositions can be cultured in any manner known in the art. In some embodiments, the edible plants are watered with a nutrient solution from the top of the container. In other embodiments, the plants are watered from the bottom, e.g., in a flood table or in holes of a pipe through which nutrient solution passes through.

In some embodiments, the plants are watered on a bench through which tubes with tiny holes (“drip tubes”) are laid, with an absorbent material over the tubes. The plant with container and media are placed on the bench. In practice, the plants are watered by filling the tubes with water or nutrient solution, which leaks through the holes onto the absorbent material. The water or nutrient solution is then absorbed on to the media, where it is available for absorption by the plant. In some of these embodiments, a porous water repellant sheeting material, such as a weed mat, is placed over the absorbent material upon which the plants are placed. Such materials are advantageous in that they can periodically be removed from the bench and cleaned. Another advantage of using this watering system with a porous water repellent sheeting material on top is that the roots of the plant grow through the hole in the bottom of the container onto the material upon which the roots adhere, holding the container and plant in place. This can be useful, particularly for tall plants such as romaine lettuce, as the adhering to the roots can prevent the plant from falling over.

Also provided herewith is a food vendor selling any of the above-described edible plants. The edible plant in these embodiments is growing in the medium or media, in the container. These embodiments are not narrowly limited to any particular food vendor. Nonlimiting examples of the food vendor in these embodiments is a restaurant, food distributor, grocery, food truck, roadside stand, farmers market, retail store, online, event, theme park, and/or fair. In some embodiments, the food vendor is a restaurant. In some of those embodiments, a restaurant harvests the edible plant at a diners table, e.g., as described in US Patent Publication US 2014/0279715. In additional embodiments, a restaurant or other food vendor harvests the edible plant immediately (i.e., within 30 minutes, or 20 minutes, or 10 minutes, or 5 minutes, or 1 minute, or less than one minute) prior to consumption or sale of the plant. In other embodiments, a food vendor sells the living plant in the container to a consumer.

In further embodiments, the present invention is directed to a method of providing an edible plant to a food vendor. The method comprises providing any of the above-described edible plants to the food vendor. In some embodiments, the plant is sold to the food vendor. In other embodiments, the plant is grown by the food vendor. Any food vendor is encompassed by these embodiments, e.g., a restaurant, food distributor, grocery, food truck, roadside stand, farmers market, retail store, online, event, theme park, and/or fairground stand.

Additionally provided is a rigid container suitable for plant growth, further comprising a porous solid medium or a solid mixture of porous media inserted therein, where the medium is capable of supporting plant growth. In various embodiments, the rigid container further comprises a seed inserted into the medium. This container is fully described above in the context of the edible plant growing therein.

Further provided herewith is a cover fitting inside a top of a container for growing plants. In these embodiments, the cover is comprised of a water repellent material and has a center hole through which a plant can grow. This cover is thoroughly described above in the context of the edible plant growing through the hole.

Turning now to the drawing, FIG. 1 shows a container 1 suitable for growing plants, e.g., open at the top, and with drainage holes at the bottom, a solid medium such as rock wool that fits into the container 2, a seed 3 that can be inserted into the solid medium near the top, when the rock wool is inserted into the container, and a cover 4 comprising a slit 5, and a hole 6. In these embodiments, the solid medium cube is inserted into the container, the seed is inserted into the center of the top of the cube, the cover is placed on top of the cube, and the container and contents are subjected to conditions that induce germination of the seed, and growth of the germinated seed and subsequent plant through the hole in the cover. The slit allows for expansion of the diameter of the plant beyond the diameter of the hole. The slit is also useful for putting the cover on a plant that is already growing out of the cube and is a larger diameter than the hole.

In view of the above, it will be seen that several objectives of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

What is claimed is:

1. An edible plant, alive and growing in a container comprising a porous, solid medium or a solid mixture of porous media, transported from its growing area to a food vendor.

2. The edible plant of claim 1, wherein the food vendor is a grocery, farmer's market or restaurant.

3. The edible plant of claim 1, wherein the container comprises a porous solid medium, wherein the porous solid medium a mineral wool.

4. The edible plant of claim 3, wherein the mineral wool is rock wool.

5. The edible plant of claim 1, wherein the medium is a solid mixture of porous media comprising soil.

6. The edible plant of claim 1, wherein the container is constructed of rigid plastic.

7. The edible plant of claim 1, wherein the container is plastic, square along the top, and 2″ in diameter.

8. The edible plant of claim 1, wherein the edible plant was grown by a separate entity than the food vendor.

9. The edible plant of claim 1, wherein the edible plant is tomato, pepper, bean, green onion, chive, leek, pea, cauliflower, Brussels sprout, celery, horseradish, asparagus, kale, sorrel, endive, spinach, lettuce, arugula, cabbage, bok choy, mustard, Swiss chard, basil, rosemary, thyme, cilantro, bay, dill, fennel, marjoram, mint, oregano, parsley, sage, savory, tarragon, chervil, dill, spearmint, watercress, lemon balm, rosemary, thyme, an edible flower, alfalfa sprouts, bean sprouts, quinoa sprouts, chia sprouts, white mushroom, shiitake mushroom, cremini mushroom, oyster mushroom, portabella mushroom, or truffle.

10. The edible plant of claim 1, wherein the edible plant is lettuce, arugula or basil.

11. The edible plant of claim 1, further comprising a water repelling cover over the surface of the solid medium or solid mixture of porous media.

12. The edible plant of claim 11, wherein the cover is made from vinyl and further comprises a center hole.

13. The edible plant of claim 12, wherein the cover has a slit extending from the center hole to the covers edge.

14. The edible plant of claim 11, wherein the cover is sized suitable to cover the medium, or media of the edible plant.

15. A food vendor selling the edible plant of claim 1.

16. The food vendor of claim 15, wherein the food vendor is a restaurant, food distributor, grocery, food truck, roadside stand, farmers market, retail store, online, event, theme park, and/or fair.

17. The food vendor of claim 15, wherein a restaurant harvests the edible plant at a diners table.

18. A method of providing an edible plant to a food vendor, the method comprising providing the edible plant of claim 1.

19. A rigid container suitable for plant growth, further comprising a porous solid medium or a solid mixture of porous media inserted therein.

20. A cover fitting inside a top of a container for growing plants, wherein the cover is comprised of a water repellent material and has a center hole through which a plant can grow.
